(19) United States
(12) Patent Application Publication
(10) Pub. No.: US 2023/0275708 A1
(43) Pub. Date: Aug. 31, 2023

(54) Methods And Apparatus For Cross-Carrier HARQ Transmissions

(71) Applicant: MediaTek Singapore Pte. Ltd., Singapore (SG)

(72) Inventors: Abdellatif Salah, Cambridge (GB); Mohammed S Aleabe Al-Imari, Cambridge (GB); Jozsef Gabor Nemeth, Cambridge (GB); Cheng-Hsun Li, Hsinchu City (TW)

(21) Appl. No.: 18/013,221

(22) PCT Filed: Jun. 30, 2021
(86) PCT No.: PCT/CN2021/103620

§ 371 Date: Dec. 27, 2022

Related U.S. Application Data
(60) Provisional application No. 63/045,924, filed on Jun. 30, 2020.

(51) Int. Cl. H04L 1/1867; H04L 5/00

(52) U.S. Cl. CPC H04L 1/1887; H04L 5/001

(57) ABSTRACT

Various solutions for cross-carrier hybrid automatic repeat request (HARQ) transmissions in wireless communications are described. An apparatus performs a HARQ initial transmission on a first component carrier (CC). The apparatus then performs a HARQ retransmission on a second CC different from the first CC.

### CROSS REFERENCE TO RELATED APPLICATIONS

The present disclosure is part of U.S. National Stage filing of International Patent Application No. PCT/CN2021/103620, filed on 30 Jun. 2021, which is part of a non-provisional application claiming the priority benefit of U.S. Patent Application No. 63/045,924, filed on 30 Jun. 2020, the contents of which being incorporated by reference in their entirety.

### FIELD OF THE INVENTION

The present disclosure is generally related to mobile communications and, more particularly, to cross-carrier hybrid automatic repeat request (HARQ) transmissions in wireless communications.

### BACKGROUND OF THE INVENTION

Unless otherwise indicated herein, approaches described in this section are not prior art to the claims listed below and are not admitted as prior art by inclusion in this section.

In wireless communications, such as mobile communications based on the 3rd Generation Partnership Project (3GPP) specification(s) for 5th Generation (5G) New Radio (NR) and beyond, the uplink (UL) and downlink (DL) time-division duplexing (TDD) pattern in TDD transmissions tends to be the bottleneck for Ultra-Reliable Low-Latency Communication (URLLC) latency. Currently (in Release 15 and Release 16 of the 3GPP specification), each component carrier (CC) is associated with its respective HARQ process pool. In other words, each HARQ process is tied to a given CC. However, this is a limitation on TDD cross-carrier retransmission scheduling in that HARQ retransmissions take place on the same CC as the corresponding initial transmission. Therefore, there is a need for a solution for latency enhancement in carrier aggregation (CA) with TDD carriers.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure are believed to address issues pertaining to cross-carrier HARQ transmissions in wireless communications as HARQ retransmissions across CCs may lead to latency enhancement in CA with TDD carriers.

In one aspect, a method may involve performing a HARQ initial transmission on a first CC. The method may also involve performing a HARQ retransmission on a second CC different from the first CC.

In another aspect, an apparatus may include a transceiver and a processor coupled to the transceiver. The transceiver may be configured to communicate wirelessly. The processor may be configured to perform, via the transceiver, a HARQ initial transmission on a first CC. The processor may also be configured to perform, via the transceiver, a HARQ retransmission on a second CC different from the first CC.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT) and non-terrestrial network (NTN) communications, the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a block diagram of an example communication apparatus and an example network apparatus in accordance with an implementation of the present disclosure.

FIG. 6 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to cross-carrier HARQ transmissions in wireless communications. According to the present disclosure, a number of possible solutions may be implemented separately or jointly. That is, although these possible solutions may be described below separately, two or more of these possible solutions may be implemented in one combination or another.

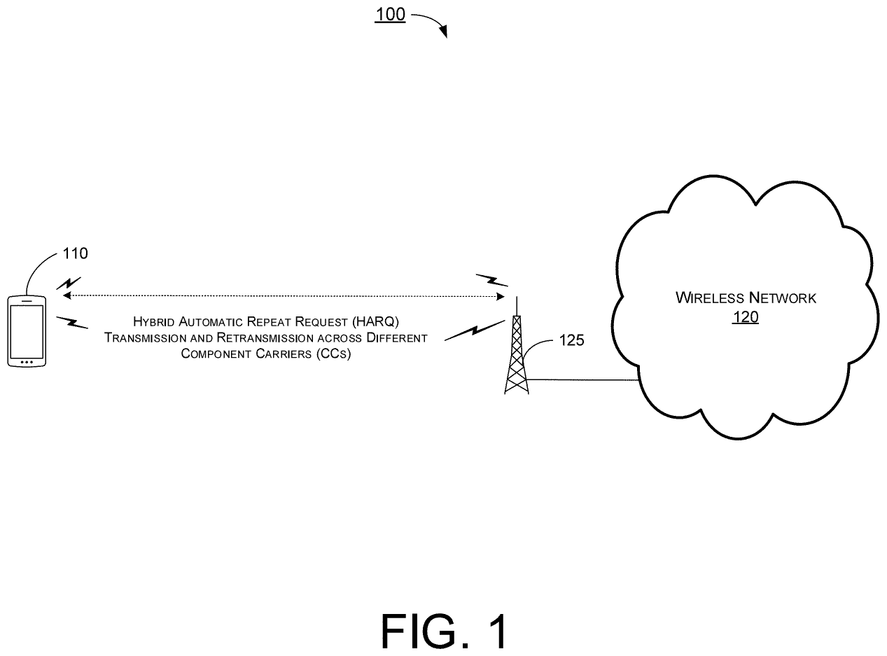

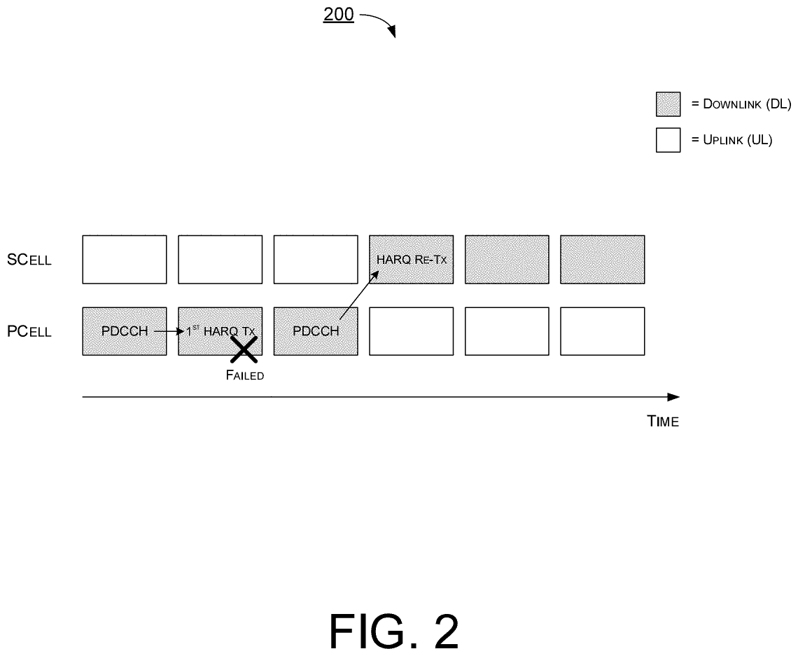

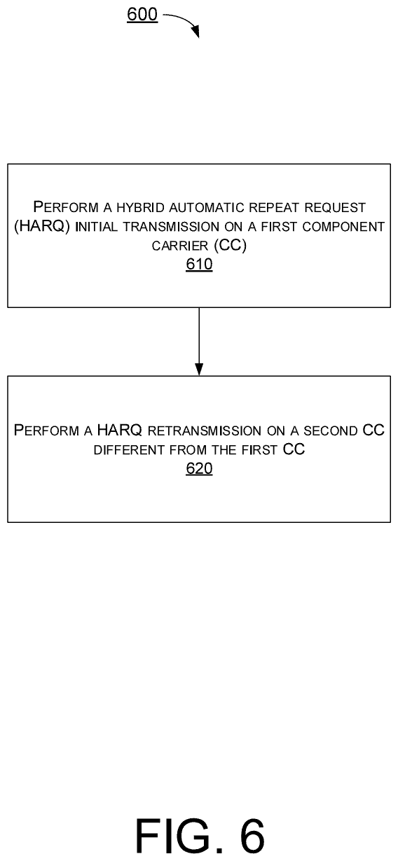

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6.

Referring to FIG. 1, network environment 100 may involve a UE 110 in wireless communication with a wireless network 120 (e.g., a 5G NR mobile network or another type of network such as an NTN). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to cross-carrier HARQ transmissions in wireless communications, as described below.

It is noteworthy that various proposed schemes described herein may be applicable for frequency range 1 (FR1) versus frequency range 2 (FR2) scenarios, unlicensed versed licensed scenarios, and frequency-division duplexing (FDD) versus TDD scenarios. That is the proposed schemes described herein may be applied in situations in which different CCs in FR1 and FR2 such that one CC in FR1 (or FR2) may be used for an initial HARQ transmission and another CC in FR2 (or FR1) may be used for one or more corresponding HARQ retransmissions. Similarly, the proposed schemes described herein may be applied in situations in which different CCs in unlicensed and licensed frequency bands such that one CC in an unlicensed (or licensed) band may be used for an initial HARQ transmission and another CC in a licensed (or unlicensed) band may be used for one or more corresponding HARQ retransmissions. Likewise, the proposed schemes described herein may be applied in situations in which different CCs in FDD and TDD such that one CC in FDD (or TDD) may be used for an initial HARQ transmission and another CC in TDD (or FDD) may be used for one or more corresponding HARQ retransmissions.

Under a first proposed scheme in accordance with the present disclosure, regarding HARQ transmissions across CCs, an initial HARQ transmission may be sent on one particular CC and its associated HARQ retransmission(s) may be scheduled and sent on another CC. For instance, the HARQ transmissions (including the initial transmission and subsequent retransmission(s)) may be sent on a primary cell (PCell) or any secondary cell (SCell). FIG. 2 illustrates an example scenario 200 under the proposed scheme. In scenario 200, a physical downlink control channel (PDCCH) transmission may schedule an initial HARQ transmission (denoted as “1st HARQ Tx” in FIG. 2) to be performed by network node 125 on a PCell, followed by the initial transmission on the PCell. Upon failure of the initial transmission (e.g., network node 125 receiving a negative acknowledgement (NACK) from UE 110), another PDCCH transmission may schedule a HARQ retransmission (denoted as “HARQ Re-Tx” in FIG. 2) to be performed by network node 125 on a SCell, followed by the HARQ retransmission on the SCell.

Under a second proposed scheme in accordance with the present disclosure, regarding HARQ process pools with cross-carrier HARQ transmissions, there may be several options in defining or otherwise configuring the HARQ process pools. In a first option (Option 1) under the proposed scheme, common HARQ process pools may be defined per cell group (e.g., per physical uplink control channel (PUCCH) group or a certain group of cells). Regarding a maximum number of HARQ processes in the pool, the maximum number of HARQ processes may be configurable by radio resource control (RRC) signaling per cell group (e.g., PUCCH group or a certain group of cells). Alternatively, the maximum number of HARQ processes in the pool may be the sum of the maximum HARQ processes supported for all CCs in the pool.

In a second option (Option 2) under the proposed scheme, information may be exchanged between two HARQ process pools. Under one approach, a mapping between the HARQ process for an initial transmission on a specific CC and the HARQ process for a retransmission on another CC may be determined. Information on the mapping may be semi-statically (e.g., via RRC signaling) or dynamically configured. For instance, a HARQ process with an index “m” on CC1 may be dedicated for retransmissions of a HARQ process with index “n” on CC2. A new downlink control information (DCI) bit-field may be included to indicate the cross-carrier HARQ transmissions. When the DCI bit-field is set to 1, it may indicate that the scheduled transmission is a retransmission associated to an initial/previous transmission on another CC (determined based on the mapping). When the new DCI bit-field is set to 0, it may indicate a same-CC scheduling. When the new DCI bit-field (for indication of cross-carrier HARQ transmissions) is set to 1, a new data indicator (NDI) may be not toggled to indicate that HARQ retransmission of the associated HARQ process is on another CC. Alternatively, when the DCI bit-field is set to 1, the NDI may be toggled to indicate one of three possibilities: (1) error case; (2) new transmission is on the current CC and the new DCI bit-field is ignored; and (3) new transmission is on another CC. Still alternatively, when the DCI bit-field is set to 1, the NDI may be ignored.

The above-described approach may be extended to cases of multiple CCs (e.g., using a lookup table). For instance, the above-described approach may be extended to multiple CCs and a CC index of the associated CC (on which the previous HARQ transmission took place) may be signaled in a DCI. Alternatively, one mapping to multiple mappings may be configured and the DCI may indicate the CC concerned with the retransmission within that mapping. For instance, a HARQ process with an index “m” on CC1 may be dedicated for retransmissions of a HARQ process with an index “n” on CC2 and index “k” on CC3. In such cases, the DCI may indicate which CC (either CC2 or CC3) is selected for retransmission(s).

Under another approach for the second option with respect to information exchange between two HARQ process pools, new DCI fields may be included in a DCI scheduling physical uplink shared channel (PUSCH) and/or physical downlink shared channel (PDSCH) for the retransmission to indicate the carrier index and/or the HARQ identifier (ID) corresponding to the initial transmission. This may be applicable only for retransmissions (e.g., with NDI not toggled). Alternatively, the NDI may be utilized differently. For instance, the NDI may be not toggled to indicate HARQ retransmission of the associated HARQ process is on another CC. Alternatively, the NDI may be toggled to indicate three possibilities: (1) error case; (2) new transmission is on the current CC and the new DCI bit-field is ignored; and (3) new transmission is on another CC. Still alternatively, the NDI may be ignored.

As an illustrative example, a New_CCindex may indicate the carrier of the previous HARQ transmission and a carrier indicator field (CIF) may be a legacy bit-field indicating the carrier on which the PDSCH/PUSCH transmission is taking place. In this example, as initial HARQ status, NDI=0 for HARQ0 (on CC1) and NDI=1 for HARQ0 (on CC2). The status of new HARQ transmission may be as follows:
New DCI→HARQ0, CIF=2, New_CCindex=2, NDI=0 or 1→OK
New DCI→HARQ0, CIF=2, New_CCindex=1, NDI=0→retransmission from HARQ0 (on CC1)
New DCI→HARQ0, CIF=2, New_CCindex=1, NDI=1→option 1: new transmission using HARQ0 (on CC1); option 2: new transmission using HARQ0 (on CC2)

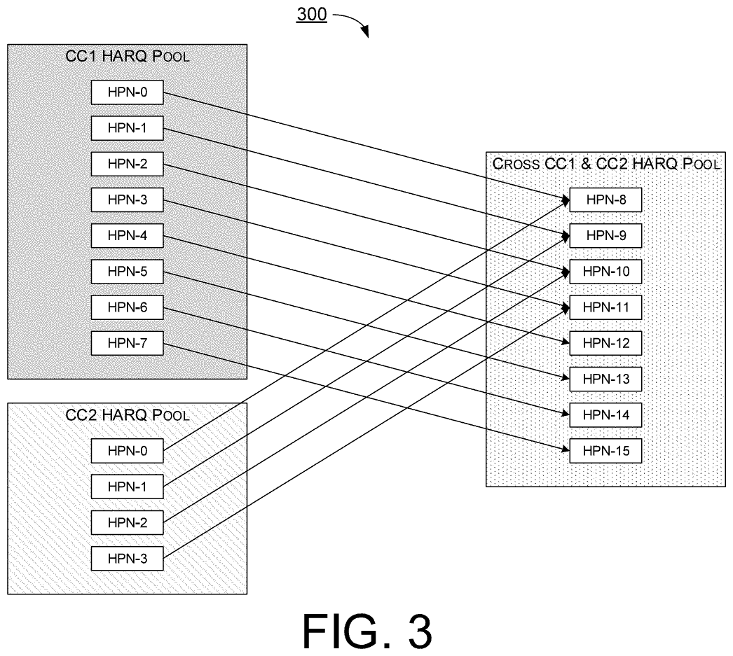

In a third option (Option 3) under the proposed scheme, a new separate HARQ process pool may be dedicated for cross-carrier HARQ transmissions. Under one approach, a mapping between HARQ processes of a same-CC HARQ process pool and a cross-CC HARQ process pool may be determined. Each CC may correspond to a respective HARQ entity with the associated pool of HARQ processes (e.g., as in Release 15 and Release 16 of the 3GPP specification). Additionally, a new cross-carrier HARQ process pool may be defined. FIG. 3 illustrates an example scenario 300 under the proposed scheme. In scenario 300, a one-to-one mapping between the processes of the same-CC HARQ process pool and the cross-CC HARQ process pool may be defined. RRC parameters for cross-CC HARQ process pool may be signaled per CC or for all CCs. In scenario 300, a same-pool (for CC1) HARQ process pool may be defined to support HARQ process numbers (HPNs) HPN-0˜HPN-7, and another same-pool (for CC2) HARQ process pool may be defined to support HPNs HPN-0˜HPN-3. Moreover, a cross-CC (for CC1 and CC2) HARQ process pool may be defined to support HPNs HPN-8˜HPN-15. In scenario 300, initial transmissions may be performed using either the CC1 HARQ process pool or the CC2 HARQ process pool, and retransmissions may be performed using the cross-CC HARQ process pool.

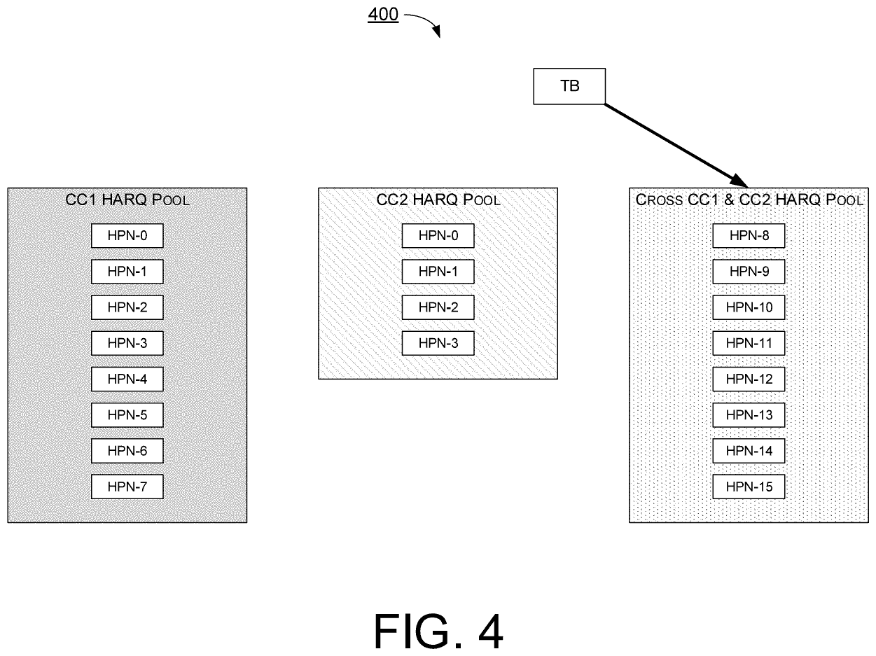

Under another approach for the third option with respect to using a separate HARQ process pool dedicated for cross-carrier HARQ transmissions, there may be no mapping between HARQ processes of a same-CC HARQ process pool and a cross-CC HARQ process pool. Under this approach, a cross-CC HARQ process pool may be a common HARQ process pool per cell group. For any transport block (TB) that is required to be transmitted or retransmitted across CCs (e.g., a high-priority TB, a TB with a specific radio network temporary identifier (RNTI), or a TB scheduled with a specific DCI format) may be selected for initial HARQ transmission and retransmission(s). RRC parameters for cross-CC HARQ process pool may be signaled per CC or for all CCs. The UE capability of UE 110 may be defined on how many HARQ processes in the common pool. Alternatively, or additionally, the UE capability of UE 110 may be defined on the number of TBs per slot for cross-carrier HARQ transmissions. FIG. 4 illustrates an example scenario 400 under the proposed scheme. In scenario 400, an initial transmission with HARQ=0 may be on CC1, and a retransmission with HARQ=10 on CC1 or CC2. In scenario 400, a same-pool (for CC1) HARQ process pool may be defined to support HPNs HPN-0˜HPN-7 for one through eight same-CC HARQ transmissions, and another same-pool (for CC2) HARQ process pool may be defined to support HPNs HPN-0˜HPN-3 for one through four same-CC HARQ transmissions (with four unused HARQ process IDs (HPIDs)). Moreover, a cross-CC (for CC1 and CC2) HARQ process pool may be defined to support HPNs HPN-8˜HPN-15 for nine through sixteen cross-CC HARQ transmissions.

Under a third proposed scheme in accordance with the present disclosure, certain restrictions may be placed on HARQ transmissions across CCs. For instance, cross-carrier HARQ retransmissions may be restricted to a PUCCH group, cell group or newly-defined group of cells. Alternatively, or additionally, cross-carrier HARQ retransmissions may be restricted to carriers with the same numerology. Alternatively, or additionally, cross-carrier HARQ retransmissions may be restricted to a specific traffic type (e.g., URLLC, extended reality (XR) and/or cloud gaming) or a specific traffic priority. For instance, cross-carrier HARQ retransmissions may be restricted to a specific RNTI (e.g., cell RNTI (C-RNTI) or modulation coding scheme C-RNTI (MCS-C-RNTI)), search space, or different DCI format and/or size (e.g., DCI format 0_2 and/or DCI format 1_2). Moreover, cross-carrier HARQ retransmissions may be restricted to a high-priority traffic (e.g., only PDSCH with a high-priority HARQ acknowledgement (HARQ-ACK)).

Under a fourth proposed scheme in accordance with the present disclosure, HARQ transmissions across CCs may be defined as a UE capability and the UE (e.g., UE 110) may report its support of such capability (e.g., to network 120 via network node 125). In case UE 110 reports the support of this capability, network 120 may configure (or not) UE 110 with this feature. Alternatively, or additionally, HARQ transmissions across CCs with different numerologies may be defined as a UE capability and the UE may report its support of such capability. In case UE 110 reports the support of this capability, network 120 may configure (or not) UE 110 with this feature. Under the proposed scheme, the number of CCs for cross-carrier HARQ transmissions may be reported as a UE capability. There may be a limitation on the number of CCs where a retransmission can occur. For example, there may be a limit on the CCs within the same HARQ process pool.

Under a fifth proposed scheme in accordance with the present disclosure, soft combining for HARQ transmissions across CCs in DL transmission may be defined as a UE capability and the UE (e.g., UE 110) may report its support of such capability (e.g., to network 120 via network node 125). In case UE 110 reports the support of this capability, network 120 may configure (or not) UE 110 with this feature. In case soft combining for HARQ transmissions across CCs is disabled, self-decodable redundancy versions may be used for HARQ transmissions and retransmissions.

Under a sixth proposed scheme in accordance with the present disclosure, code block group (CBG)-based transmissions and retransmissions may be enabled or disabled on all carriers on which HARQ transmissions across CCs are used. For instance, it may not be allowed to have CBG-based transmissions enabled on the carrier transmitting the initial HARQ transmission and CBG-based transmissions disabled on the carrier transmitting the corresponding HARQ retransmission. Under the proposed scheme, carriers (e.g., in a PUCCH group, a cell group or a new group of cells) on which HARQ transmissions across CCs is enabled may have the same CBG configuration. For instance, CBG-based transmissions may be defined or otherwise configured per PUCCH group, per cell group (or for a newly defined group of cells). Moreover, under the proposed scheme, one or more RRC parameters may be shared between carriers (and hence configured to a group of carriers instead of a single carrier). Such one or more RRC parameters may include, for example, a flag to enable and configure CBG-based transmission(s), a maximum number of CBG per TB, and a parameter to indicate whether CBG flushing-out information (CBGFI) for CBG-based (re)transmissions in DL is enabled.

Under a seventh proposed scheme in accordance with the present disclosure, HARQ transmissions across CCs may be enabled or disabled separately for UL and DL transmissions (e.g., for PDSCHs and PUSCHs). Under the proposed scheme, HARQ transmissions across CCs may be specified as separate capabilities for UL and DL transmissions. The UE (e.g., UE 110) may report its support of these capabilities. For instance, UE 110 may report that it support cross-carrier HARQ transmissions for DL but not for UL (or vice versa).

### Illustrative Implementations

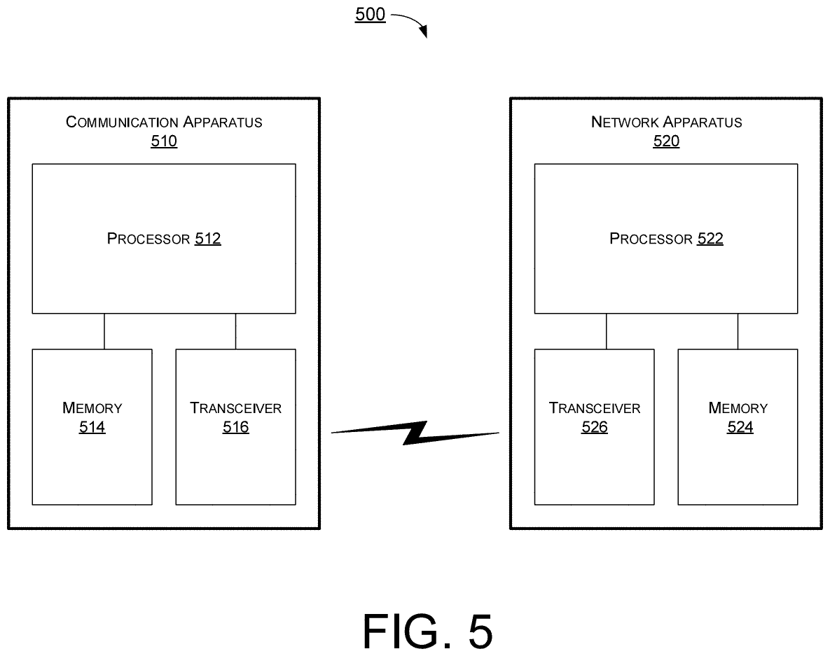

FIG. 5 illustrates an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to cross-carrier HARQ transmissions in wireless communications, including scenarios/schemes described herein.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus/station, which may be a network node such as a base station, a small cell, a router, a gateway or a satellite. For instance, network apparatus 520 may be implemented in an eNodeB in an LTE, in a gNB in a 5G, NR, IoT, NB-IoT, IIoT, or in a satellite in an NTN network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including power consumption reduction in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively.

Each of communication apparatus 510 and network apparatus 520 may be a communication entity capable of communicating with each other using various proposed schemes in accordance with the present disclosure. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE (e.g., UE 110) and network apparatus 520 is implemented in or as a network node or base station (e.g., network node 125) of a communication network (e.g., wireless network 120). It is also noteworthy that, although the example implementations described below are provided in the context of mobile communications, the same may be implemented in other types of networks.

Under a proposed scheme pertaining to cross-carrier HARQ transmissions in wireless communications in accordance with the present disclosure, with communication apparatus 510 implemented in or as UE 110 and network apparatus 520 implemented in or as network node 125 in network environment 100, processor 512 of communication apparatus 510 and processor 522 of network apparatus 520 may perform a HARQ initial transmission on a first CC. For instance, processor 512 may receive, via transceiver 516, the HARQ initial transmission on the first CC. Similarly, processor 522 may transmit, via transceiver 526, the HARQ initial transmission on the first CC. Additionally, processor 512 of communication apparatus 510 and processor 522 of network apparatus 520 may perform a HARQ retransmission on a second CC different from the first CC. For instance, processor 512 may receive, via transceiver 516, the HARQ retransmission on the second CC. Similarly, processor 522 may transmit, via transceiver 526, the HARQ retransmission on the second CC.

In some implementations, the HARQ initial transmission and the HARQ retransmission may be performed based on at least one of a first arrangement, a second arrangement, a third arrangement and a fourth arrangement. The first arrangement may involve either: (a) the first CC being in FR1 and the second CC being in FR2 different from the FR1, or (b) the first CC being in the FR2 and the second CC being in the FR1. The second arrangement may involve either: (a) the first CC being in a licensed frequency band and the second CC being in an unlicensed frequency band, or (b) the first CC being in the unlicensed frequency band and the second CC being in the licensed frequency band. The third arrangement may involve either: (a) the HARQ initial transmission being performed using FDD and the HARQ retransmission being performed using TDD, or (b) the HARQ initial transmission being performed using the TDD and the HARQ retransmission being performed using the FDD. The fourth arrangement may involve either: (a) the first CC being transmitted on a PCell and the second CC being transmitted on a SCell, or (b) the first CC being transmitted on the SCell and the second CC being transmitted on the PCell.

In some implementations, each of the HARQ initial transmission and the HARQ retransmission may be performed using a common pool of HARQ processes corresponding to both the first CC and the second CC and defined per cell group. In some implementations, a maximum number of HARQ processes in the common pool may be a sum of a maximum HARQ processes supported for all CCs in the common pool. In some implementations, processor 512 may receive or processor 522 may transmit, via a RRC signaling, a configuration on a maximum number of HARQ processes configurable per PUCCH group or for a group of cells.

In some implementations, a first HARQ process for the HARQ initial transmission may be mapped to a second HARQ process for and the HARQ retransmission. In some implementations, processor 512 may receive or processor 522 may transmit a configuration that maps the first HARQ process and the second HARQ process either semi-statically via RRC signaling or dynamically. Alternatively, or additionally, processor 512 may receive or processor 522 may transmit a DCI signaling with a DCI bit-field. In such cases, a first value of the DCI bit-field may indicate that the HARQ retransmission is scheduled on the second CC and is associated with the HARQ initial transmission performed on the first CC. Correspondingly, a second value of the DCI bit-field may indicate the HARQ retransmission is scheduled on the first CC and is associated with the HARQ initial transmission performed on the first CC. In some implementations, in an event that the DCI bit-field is set to the first value, an NDI may be treated in one of the following ways: (i) ignored; (ii) not toggled to indicate that the HARQ retransmission of an associated HARQ process is on one other CC (e.g., the second CC) different than the first CC; or (iii) toggled to indicate an error case, that a new transmission is on a current CC and that the DCI bit-field is ignored, or that the new transmission is on the other CC. Still alternatively, or additionally, processor 512 may receive or processor 522 may transmit a second DCI signaling with a DCI bit-field indicating either or both of a carrier index and a HARQ ID corresponding to the HARQ initial transmission. In such cases, the second DCI signaling with the DCI bit-field may be applicable to the HARQ retransmission. Moreover, an NDI may be either not toggled or toggled to indicate an error case, that a new transmission is on a current CC and that the DCI bit-field is ignored, or that the new transmission is on one other CC different than the first CC.

In some implementations, the HARQ initial transmission may be performed using either a first pool of HARQ processes corresponding to the first CC or a second pool of HARQ processes corresponding to the second CC. Additionally, the HARQ retransmission may be performed using a cross-CC pool of HARQ processes corresponding to both the first CC and the second CC. Moreover, each HARQ process of the first pool of HARQ processes may be mapped to a first respective HARQ process of the cross-CC pool of HARQ processes. Furthermore, each HARQ process of the second pool of HARQ processes may be mapped to a second respective HARQ process of the cross-CC pool of HARQ processes.

In some implementations, each of the HARQ initial transmission and the HARQ retransmission may be performed using any of a first pool of HARQ processes corresponding to the first CC, a second pool of HARQ processes corresponding to the second CC, or a common pool of HARQ processes corresponding to both the first CC and the second CC. In some implementations, there may be no mapping between the first pool of HARQ processes and the common pool of HARQ processes. Additionally, there may be no mapping between the second pool of HARQ processes and the common pool of HARQ processes.

In some implementations, a first UE capability may be defined on a number of HARQ processes in the common pool of HARQ processes. Alternatively, or additionally, a second UE capability may be defined on a number of TBs per slot for cross-carrier HARQ transmissions.

### Illustrative Processes

FIG. 6 illustrates an example process 600 in accordance with an implementation of the present disclosure. Process 600 may be an example implementation of schemes described above, whether partially or completely, with respect to cross-carrier HARQ transmissions in wireless communications in accordance with the present disclosure. Process 600 may represent an aspect of implementation of features of communication apparatus 510 and network apparatus 520. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by communication apparatus 510 (or any suitable UE or machine type devices) and network apparatus 520 (or any suitable network node). Solely for illustrative purposes and without limitation, process 600 is described below in the context of communication apparatus 510 and network apparatus 520. Process 600 may begin at block 610.

At 610, process 600 may involve processor 512 of communication apparatus 510 and processor 522 of network apparatus 520 performing a HARQ initial transmission on a first CC. For instance, process 600 may involve processor 512 receiving, via transceiver 516, the HARQ initial transmission on the first CC. Similarly, process 600 may involve processor 522 transmitting, via transceiver 526, the HARQ initial transmission on the first CC. Process 600 may proceed from 610 to 620.

At 620, process 600 may involve processor 512 of communication apparatus 510 and processor 522 of network apparatus 520 performing a HARQ retransmission on a second CC different from the first CC. For instance, process 600 may involve processor 512 receiving, via transceiver 516, the HARQ retransmission on the second CC. Similarly, process 600 may involve processor 522 transmitting, via transceiver 526, the HARQ retransmission on the second CC.

In some implementations, the HARQ initial transmission and the HARQ retransmission may be performed based on at least one of a first arrangement, a second arrangement, a third arrangement and a fourth arrangement. The first arrangement may involve either: (a) the first CC being in FR1 and the second CC being in FR2 different from the FR1, or (b) the first CC being in the FR2 and the second CC being in the FR1. The second arrangement may involve either: (a) the first CC being in a licensed frequency band and the second CC being in an unlicensed frequency band, or (b) the first CC being in the unlicensed frequency band and the second CC being in the licensed frequency band. The third arrangement may involve either: (a) the HARQ initial transmission being performed using FDD and the HARQ retransmission being performed using TDD, or (b) the HARQ initial transmission being performed using the TDD and the HARQ retransmission being performed using the FDD. The fourth arrangement may involve either: (a) the first CC being transmitted on a PCell and the second CC being transmitted on a SCell, or (b) the first CC being transmitted on the SCell and the second CC being transmitted on the PCell.

In some implementations, each of the HARQ initial transmission and the HARQ retransmission may be performed using a common pool of HARQ processes corresponding to both the first CC and the second CC and defined per cell group. In some implementations, a maximum number of HARQ processes in the common pool may be a sum of a maximum HARQ processes supported for all CCs in the common pool. In some implementations, process 600 may further involve processor 512 receiving or processor 522 transmitting, via a RRC signaling, a configuration on a maximum number of HARQ processes configurable per PUCCH group or for a group of cells.

In some implementations, a first HARQ process for the HARQ initial transmission may be mapped to a second HARQ process for and the HARQ retransmission. In some implementations, process 600 may further involve processor 512 receiving or processor 522 transmitting a configuration that maps the first HARQ process and the second HARQ process either semi-statically via RRC signaling or dynamically. Alternatively, or additionally, process 600 may further involve processor 512 receiving or processor 522 transmitting a DCI signaling with a DCI bit-field. In such cases, a first value of the DCI bit-field may indicate that the HARQ retransmission is scheduled on the second CC and is associated with the HARQ initial transmission performed on the first CC. Correspondingly, a second value of the DCI bit-field may indicate the HARQ retransmission is scheduled on the first CC and is associated with the HARQ initial transmission performed on the first CC. In some implementations, in an event that the DCI bit-field is set to the first value, an NDI may be treated in one of the following ways: (i) ignored; (ii) not toggled to indicate that the HARQ retransmission of an associated HARQ process is on one other CC (e.g., the second CC) different than the first CC; or (iii) toggled to indicate an error case, that a new transmission is on a current CC and that the DCI bit-field is ignored, or that the new transmission is on the other CC. Still alternatively, or additionally, process 600 may further involve processor 512 receiving or processor 522 transmitting a second DCI signaling with a DCI bit-field indicating either or both of a carrier index and a HARQ ID corresponding to the HARQ initial transmission. In such cases, the second DCI signaling with the DCI bit-field may be applicable to the HARQ retransmission. Moreover, an NDI may be either not toggled or toggled to indicate an error case, that a new transmission is on a current CC and that the DCI bit-field is ignored, or that the new transmission is on one other CC different than the first CC.

In some implementations, the HARQ initial transmission may be performed using either a first pool of HARQ processes corresponding to the first CC or a second pool of HARQ processes corresponding to the second CC. Additionally, the HARQ retransmission may be performed using a cross-CC pool of HARQ processes corresponding to both the first CC and the second CC. Moreover, each HARQ process of the first pool of HARQ processes may be mapped to a first respective HARQ process of the cross-CC pool of HARQ processes. Furthermore, each HARQ process of the second pool of HARQ processes may be mapped to a second respective HARQ process of the cross-CC pool of HARQ processes.

In some implementations, each of the HARQ initial transmission and the HARQ retransmission may be performed using any of a first pool of HARQ processes corresponding to the first CC, a second pool of HARQ processes corresponding to the second CC, or a common pool of HARQ processes corresponding to both the first CC and the second CC. In some implementations, there may be no mapping between the first pool of HARQ processes and the common pool of HARQ processes. Additionally, there may be no mapping between the second pool of HARQ processes and the common pool of HARQ processes.

In some implementations, a first UE capability may be defined on a number of HARQ processes in the common pool of HARQ processes. Alternatively, or additionally, a second UE capability may be defined on a number of TBs per slot for cross-carrier HARQ transmissions.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
performing a hybrid automatic repeat request (HARQ) initial transmission on a first component carrier (CC); and
performing a HARQ retransmission on a second CC different from the first CC.

2. The method of claim 1, wherein the HARQ initial transmission and the HARQ retransmission are performed based on at least one of a first arrangement, a second arrangement, a third arrangement and a fourth arrangement, and wherein:
the first arrangement comprises either:
the first CC being in a first frequency range (FR1) and the second CC being in a second frequency range (FR2) different from the FR1, or
the first CC being in the FR2 and the second CC being in the FR1;
the second arrangement comprises either:
the first CC being in a licensed frequency band and the second CC being in an unlicensed frequency band, or
the first CC being in the unlicensed frequency band and the second CC being in the licensed frequency band;
the third arrangement comprises either:
the HARQ initial transmission being performed using frequency-division duplexing (FDD) and the HARQ retransmission being performed using time-division duplexing (TDD), or
the HARQ initial transmission being performed using the TDD and the HARQ retransmission being performed using the FDD; and
the fourth arrangement comprises either:
the first CC being transmitted on a primary cell (PCell) and the second CC being transmitted on a secondary cell (SCell), or
the first CC being transmitted on the SCell and the second CC being transmitted on the PCell.

3. The method of claim 1, wherein each of the HARQ initial transmission and the HARQ retransmission is performed using a common pool of HARQ processes corresponding to both the first CC and the second CC and defined per cell group.

4. The method of claim 3, wherein a maximum number of HARQ processes in the common pool is a sum of a maximum HARQ processes supported for all CCs in the common pool.

5. The method of claim 3, further comprising:
receiving or transmitting, via a radio resource control (RRC) signaling, a configuration on a maximum number of HARQ processes configurable per physical uplink control channel (PUCCH) group or for a group of cells.

6. The method of claim 1, wherein a first HARQ process for the HARQ initial transmission is mapped to a second HARQ process for and the HARQ retransmission.

7. The method of claim 6, further comprising:
receiving or transmitting a configuration that maps the first HARQ process and the second HARQ process either semi-statically via radio resource control (RRC) signaling or dynamically.

8. The method of claim 6, further comprising:
receiving or transmitting a downlink control information (DCI) signaling with a DCI bit-field,
wherein a first value of the DCI bit-field indicates that the HARQ retransmission is scheduled on the second CC and is associated with the HARQ initial transmission performed on the first CC, and
wherein a second value of the DCI bit-field indicates the HARQ retransmission is scheduled on the first CC and is associated with the HARQ initial transmission performed on the first CC.

9. The method of claim 8, wherein, in an event that the DCI bit-field is set to the first value, a new data indicator (NDI) is:
ignored;
not toggled to indicate that the HARQ retransmission of an associated HARQ process is on one other CC different than the first CC; or
toggled to indicate an error case, that a new transmission is on a current CC and that the DCI bit-field is ignored, or that the new transmission is on the other CC.

10. The method of claim 6, further comprising:
receiving or transmitting a downlink control information (DCI) signaling with a DCI bit-field indicating either or both of a carrier index and a HARQ identifier (ID) corresponding to the HARQ initial transmission.

11. The method of claim 10, wherein the DCI signaling with the DCI bit-field is applicable to the HARQ retransmission, and wherein a new data indicator (NDI) is either not toggled or toggled to indicate an error case, that a new transmission is on a current CC and that the DCI bit-field is ignored, or that the new transmission is on one other CC different than the first CC.

12. The method of claim 1, wherein the HARQ initial transmission is performed using either a first pool of HARQ processes corresponding to the first CC or a second pool of HARQ processes corresponding to the second CC, wherein the HARQ retransmission is performed using a cross-CC pool of HARQ processes corresponding to both the first CC and the second CC, wherein each HARQ process of the first pool of HARQ processes is mapped to a first respective HARQ process of the cross-CC pool of HARQ processes, and wherein each HARQ process of the second pool of HARQ processes is mapped to a second respective HARQ process of the cross-CC pool of HARQ processes.

13. The method of claim 1, wherein each of the HARQ initial transmission and the HARQ retransmission is performed using any of a first pool of HARQ processes corresponding to the first CC, a second pool of HARQ processes corresponding to the second CC, or a common pool of HARQ processes corresponding to both the first CC and the second CC.

14. The method of claim 13, wherein there is no mapping between the first pool of HARQ processes and the common pool of HARQ processes, and wherein there is no mapping between the second pool of HARQ processes and the common pool of HARQ processes.

15. The method of claim 13, wherein either or both:
a first user equipment (UE) capability is defined on a number of HARQ processes in the common pool of HARQ processes, and
a second UE capability is defined on a number of transport blocks (TBs) per slot for cross-carrier HARQ transmissions.

16. An apparatus, comprising:
a transceiver configured to communicate wirelessly; and
a processor coupled to the transceiver and configured to perform operations comprising:
performing, via the transceiver, a hybrid automatic repeat request (HARQ) initial transmission on a first component carrier (CC); and
performing, via the transceiver, a HARQ retransmission on a second CC different from the first CC,
wherein the HARQ initial transmission and the HARQ retransmission are performed based on at least one of a first arrangement, a second arrangement, a third arrangement and a fourth arrangement, and
wherein:
the first arrangement comprises either:
the first CC being in a first frequency range (FR1) and the second CC being in a second frequency range (FR2) different from the FR1, or
the first CC being in the FR2 and the second CC being in the FR1;
the second arrangement comprises either:
the first CC being in a licensed frequency band and the second CC being in an unlicensed frequency band, or
the first CC being in the unlicensed frequency band and the second CC being in the licensed frequency band;
the third arrangement comprises either:
the HARQ initial transmission being performed using frequency-division duplexing (FDD) and the HARQ retransmission being performed using time-division duplexing (TDD), or
the HARQ initial transmission being performed using the TDD and the HARQ retransmission being performed using the FDD; and
the fourth arrangement comprises either:
the first CC being transmitted on a primary cell (PCell) and the second CC being transmitted on a secondary cell (SCell), or
the first CC being transmitted on the SCell and the second CC being transmitted on the PCell.

17. The apparatus of claim 16, wherein each of the HARQ initial transmission and the HARQ retransmission is performed using a common pool of HARQ processes corresponding to both the first CC and the second CC and defined per cell group, and wherein a maximum number of HARQ processes in the common pool is a sum of a maximum HARQ processes supported for all CCs in the common pool.

18. The apparatus of claim 16, wherein a first HARQ process for the HARQ initial transmission is mapped to a second HARQ process for and the HARQ retransmission, wherein the processor is further configured to perform operations comprising at least one of:
receiving or transmitting, via the transceiver, a configuration that maps the first HARQ process and the second HARQ process either semi-statically via radio resource control (RRC) signaling or dynamically;
receiving or transmitting, via the transceiver, a downlink control information (DCI) signaling with a DCI bit-field; and
receiving or transmitting a downlink control information (DCI) signaling with a DCI bit-field indicating either or both of a carrier index and a HARQ identifier (ID) corresponding to the HARQ initial transmission,
wherein a first value of the DCI bit-field indicates that the HARQ retransmission is scheduled on the second CC and is associated with the HARQ initial transmission performed on the first CC,
wherein a second value of the DCI bit-field indicates the HARQ retransmission is scheduled on the first CC and is associated with the HARQ initial transmission performed on the first CC,
wherein the DCI signaling with the DCI bit-field is applicable to the HARQ retransmission, and
wherein a new data indicator (NDI) is either not toggled or toggled to indicate an error case, that a new transmission is on a current CC and that the DCI bit-field is ignored, or that the new transmission is on one other CC different than the first CC.

19. The apparatus of claim 16, wherein the HARQ initial transmission is performed using either a first pool of HARQ processes corresponding to the first CC or a second pool of HARQ processes corresponding to the second CC, wherein the HARQ retransmission is performed using a cross-CC pool of HARQ processes corresponding to both the first CC and the second CC, wherein each HARQ process of the first pool of HARQ processes is mapped to a first respective HARQ process of the cross-CC pool of HARQ processes, and wherein each HARQ process of the second pool of HARQ processes is mapped to a second respective HARQ process of the cross-CC pool of HARQ processes.

20. The apparatus of claim 16, wherein each of the HARQ initial transmission and the HARQ retransmission is performed using any of a first pool of HARQ processes corresponding to the first CC, a second pool of HARQ processes corresponding to the second CC, or a common pool of HARQ processes corresponding to both the first CC and the second CC.
